(19) United States
(12) Patent Application Publication
(10) Pub. No.: US 2013/0048031 A1
(43) Pub. Date: Feb. 28, 2013

(54) LENS WASHING SYSTEMS AMD METHODS FOR SURGICAL TELESCOPIC INSTRUMENTS

(71) Applicant: Darin Minkin, Chesterfield, MO (US)

(72) Inventor: Darin Minkin, Chesterfield, MO (US)

(21) Appl. No.: 13/220,934

(22) Filed: Aug. 30, 2011

(51) Int. Cl. B08B 3/04

(52) U.S. Cl. 134/34; 134/198; 134/184

(57) ABSTRACT

A lens washing system for cleaning the objective lens of a surgical telescopic instrument while the instrument is disposed within the body of a patient, wherein the system includes a hollow tubular sleeve disposable over a probe of a surgical telescopic instrument such that a distal end of the probe including an objective lens of the surgical telescopic instrument extends past a distal end of the sleeve. The system additionally includes a hollow tubular washing fluid conduit linearly and tangentially disposed along a longitudinal portion of an exterior surface of the sleeve such that a distal end of the conduit including a washing fluid egress port extends past the distal end and objective lens of the probe so that washing fluid dispensed from the egress port is directed onto the objective lens to wash away any debris or media obscuring the objective lens.

### FIELD

The present teachings relate to systems and methods for cleaning the objective lens of a surgical telescopic instrument while the instrument is disposed within the body of a patient.

### BACKGROUND

The statements in this section merely provide background information related to the present disclosure and may not constitute prior art.

Operative laparoscopy has replaced many simple and moderately complex surgical procedures, such as anterior cruciate ligament (ACL) and meniscus repairs, gallbladder removal, hysterectomies, and various other surgical procedures, that in the past have been done with large incisions. During such procedures a cavity is created within the body, typically via the introduction of an inert gas, adjacent and/or around the target area of the procedure, whereafter a laparoscope is introduced into a cavity to provide a means for the surgeon to see the internal target area. Particularly, the laparoscope provides light within the cavity and includes an objective lens for viewing, via an eyepiece or a video monitor, the internal target area and the movement of the selected surgical instruments introduced into the cavity to perform the particular procedure.

During such procedures, the objective lens of the laparoscope often becomes soiled with tissue particles, blood and other body fluids, which obscure what the surgeon can view through the laparoscope. Typically, when the lens gets soiled, the laparoscope needs to be removed from the body cavity so that the objective lens can be wiped clean. During some procedures, the laparoscope may need to be removed and the lens wiped clean numerous times, which can significantly delay progress of the respective procedure.

### SUMMARY

In various embodiments, the present disclosure provides a lens washing system for cleaning the objective lens of a surgical telescopic instrument while the instrument is disposed within the body of a patient. In such embodiments, the system includes a hollow tubular sleeve disposable over a probe of a surgical telescopic instrument such that a distal end of the probe including an objective lens of the surgical telescopic instrument extends past a distal end of the sleeve. The system additionally includes a hollow tubular washing fluid conduit linearly and tangentially disposed along a longitudinal portion of an exterior surface of the sleeve such that a distal end of the conduit including a washing fluid egress port extends past the distal end and objective lens of the probe so that washing fluid dispensed from the egress port is directed onto the objective lens to wash away any debris or media obscuring the objective lens.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is an illustration of a lens washing system for cleaning the objective lens of a surgical telescopic instrument while the instrument is disposed within the body of a patient, in accordance with various embodiments of the present disclosure.

FIG. 2 is an end view of the lens washing system shown in FIG. 1, in accordance with various embodiments of the present disclosure.

FIG. 3 is an end view of the lens washing system shown in FIG. 1, in accordance with various other embodiments of the present disclosure.

FIG. 4 is an illustration of a proximal end portion of the lens washing system shown in FIG. 1 having a washing fluid supply device connected thereto, in accordance with various embodiments of the present disclosure.

FIG. 5A is an illustration of a distal end portion of a sleeve of the lens washing system shown in FIG. 1 having a distal end edge that has a curved contour with regard to a longitudinal axis of the sleeve, in accordance with various embodiments of the present disclosure.

FIG. 5B is an illustration of the distal end portion of a sleeve of the lens washing system shown in FIG. 1 having the distal end edge formed to be at an angle with regard to the longitudinal axis of the sleeve, in accordance with various other embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

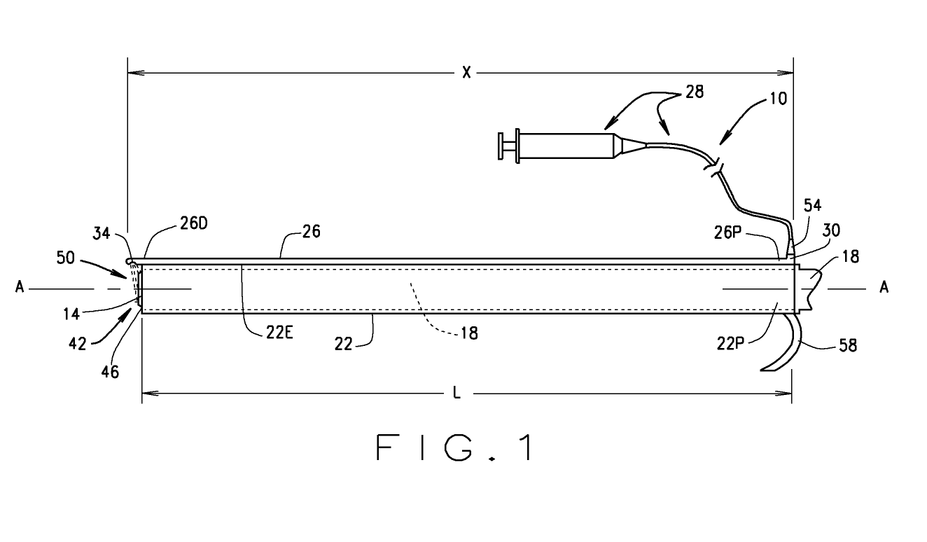

Referring to FIG. 1, the present disclosure provides a lens washing system 10 for cleaning the objective lens 14 of a surgical telescopic instrument, while a probe 18 of the surgical telescopic instrument is disposed within the body of a patient. In various embodiments, the system 10 includes a hollow tubular sleeve 22 structured to receive the surgical telescopic instrument probe 18, a hollow tubular washing fluid conduit 26 linearly and tangentially disposed along a longitudinal portion of an exterior surface 22E of the sleeve 22 and a washing fluid supply device 28.

The surgical telescopic instrument, as used herein, can be any surgical telescopic instrument presently known or unknown that is used for observation within a body cavity and/or for performing surgical procedures within the body cavity. Generally, such surgical telescopic instruments include a rigid or relatively rigid probe having an objective lens, e.g., objective lens 14, at one end and an eyepiece (not shown) or a video monitor disposed at or connectable to the opposing end. Additionally, the probe typically includes light-transmitting glass fibers that are connectable to a light source (internal or external) such that light can be transmitted from the light source onto the target anatomical features within the body cavity. Accordingly, the target anatomical features can be viewed by a surgeon via the eyepiece or video monitor.

Referring now to FIGS. 1, 2 and 3, as described above, the washing fluid conduit 26 is linearly and tangentially disposed along the exterior surface 22E of the sleeve 22, that is, the conduit 26 is tangentially disposed along a length L of exterior surface 22E. More specifically, the washing fluid conduit 26 is disposed along the exterior surface 22E such that the conduit 26 is formed with, or connected to, the exterior surface 22E non-coaxially along only a longitudinal portion of the exterior surface 22E.

The washing fluid conduit 26 includes a washing fluid supply fitting 30 disposed at a proximal end 26P of the conduit 26 and a washing fluid egress port 34 formed at a distal end 26D of the conduit 26. The washing fluid egress port 34 and the washing fluid supply fitting 30 are fluidly connected via an internal lumen 38 of the washing fluid conduit 26 such that washing fluid can be introduced into the lumen 38 under pressure via the fitting 30 and be dispensed under pressure from the lumen 38 via the egress port 34. Moreover, the washing fluid supply fitting 30 is structured and operable to detachably couple with the washing fluid supply device 28, which is structured and operable to controllably introduce washing fluid under pressure, e.g., 1 psi to 20 psi, into and internal lumen 38. Accordingly, the washing fluid provided by the washing fluid supply device 28 will flow through the internal lumen 38 and be dispensed from the washing fluid conduit 26 under pressure, via the egress port 34. As described further below, the washing fluid dispensed from the washing fluid conduit 26 is directed toward and utilized to clean the objective lens 14 of the surgical instrument probe 18.

As described above, the sleeve 22 is a hollow tubular structure. More specifically the sleeve 22 includes an interior duct 42 into which the instrument probe 18 can be inserted such that the objective lens 14 of the probe 18 is substantially even with or extends slightly past a distal end edge 46 of the sleeve. In various implementations, the sleeve 22 has the length L that is slightly shorter, e.g., 1/16 inch to ½ inch, than the length of the instrument probe 18. Accordingly, when the sleeve 22 is disposed on the probe 18, a portion of the distal end of the probe 18 including the objective lens 14 extends slightly beyond, e.g., 1/16 inch to ½ inch, the sleeve distal end edge 46. Additionally, the washing fluid conduit 26 has a length X that is slightly longer, e.g., ⅛ inch to ¾ inch, than the length L of the sleeve 22 such that the conduit distal end 26D extends slightly past, e.g., ⅛ inch to ¾ inch, the distal end edge 46 of the sleeve 22. Furthermore, the egress port 34 is disposed/formed within the conduit distal end 26D such that the egress port is positioned even with or slightly beyond the distal end and the objective lens 14 of the probe 18. Still further, the egress port 34 is formed within the conduit distal end 26D such that washing fluid dispensed from the from the washing fluid conduit 26, via the egress port 34 (illustrated as spray 50 in FIG. 1), is directed downward, and in various implementations, is angled toward the objective lens 14, to spray the objective lens 14, thereby washing any debris, fog, bodily fluids, etc., obscuring the objective lens 14 off of the objective lens 14, whereafter the debris, etc., and the washing fluid shed the lens 14 into the body cavity.

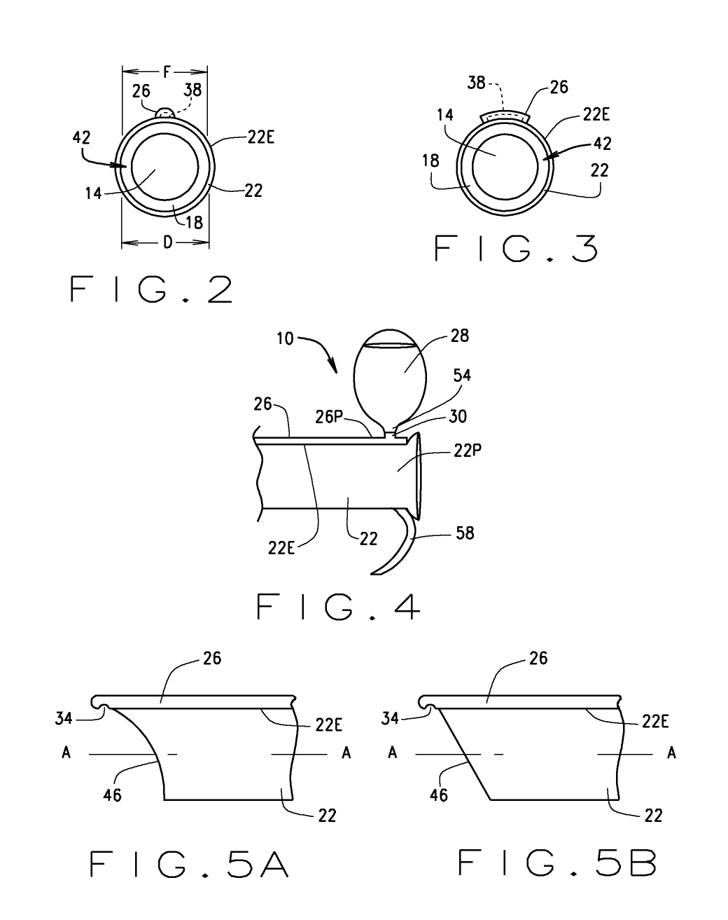

The sleeve 22 can be structured to have any cross-sectional shape that matches or compliments the cross-sectional shape of the probe 18. For example, the sleeve 22 can have a circular, oval, triangular, square, rectangular, etc., cross-sectional shape depending on the cross-sectional shape of the respective probe 18. Additionally, the sleeve 22 is structured to have an inside diameter D, or dimensions, that is substantially the same or slightly larger than an outside diameter F, or dimensions, of the probe 18 (shown in FIG. 2) such that the probe 18 is easily inserted into the sleeve 22. In various embodiments, the sleeve 22 is structured to be disposed over the probe 18 such that sleeve 22 and probe 18 have a slightly loose fit, i.e., there is little or no friction generated between the sleeve 22 and the probe 18 when the probe 18 is inserted into the sleeve 22. Alternatively, in other embodiments, the sleeve 22 is structured to be disposed over the probe 18 such that sleeve 22 and probe 18 have a snug fit, i.e., a friction fit where there is slight friction generated between the sleeve 22 and the probe 18 when the probe 18 is inserted into the sleeve 22, but not so much friction so as to make insertion of probe 18 into the sleeve 22 difficult or require significant force.

The sleeve 22 can be fabricated from any suitable bio-compatible material such as bio-compatible plastics, nylons, composites, metals, polymers, rubbers and the like. Additionally, in various embodiments, the sleeve 22 can be fabricated of a solid material, e.g., extruded, to be substantially rigid or semi-rigid such that the sleeve 22 is only slightly flexible and/or only slightly collapsible. In such embodiments, the sleeve 22 can be structured to have a slightly loose fit or a slightly snug fit with the probe 18, as described above. Alternatively, in various other embodiments, the sleeve 22 can be fabricated of a mesh or cloth-like material, e.g., a nylon mesh, such that sleeve 22 fits over the probe 18 in a sock-like manner having a snug fit, as described above. In such embodiments, the sleeve 22 is structured to have a substantially constant length L but have an expandable inside diameter D. More specifically, in such embodiments, the sleeve 22 is structured such that the inside diameter D of the sleeve 22 is smaller than the outside diameter F of the probe 18 prior to insertion of the probe 18, but the inside diameter D of the sleeve 18 will expand to be substantially the same as the outside diameter F of the probe 18 as the sleeve 22 is pulled over the probe 18.

The washing fluid conduit 26 can be structured to have any cross-sectional shape, e.g., circular, oval, triangular, square, rectangular, etc., such that the conduit 26 can be linearly and tangentially disposed along the length L of sleeve 22. For example, in various embodiments, the conduit 26 can have a substantially circular cross-sectional shape, as exemplary illustrated in FIG. 2, or in various other exemplary embodiments, the conduit 26 can have a substantially rectangular cross-sectional shape, as exemplary illustrated in FIG. 3.

Referring now to FIGS. 1 and 4, the washing fluid supply fitting 30 can be any connecting or coupling device suitable for providing a substantially water tight, or leak-free, detachable connection with a connector 54 of the washing fluid supply device 28. For example, in various embodiments, the washing fluid supply fitting 30 can be a quick twist-connect fitting, e.g., a Luer-Lok ® type fitting, structured to easily detachably connect with the washing supply device connector 54 by inserting the connector 54 into the fitting 30 and slightly turning the connector, e.g., 90° to 270° or ¼ of a turn to ¾ of a turn, to provide a leak-free connection. Alternatively, in other embodiments, the washing fluid supply fitting 30 can be a snap type fitting structured to easily detachably connect with the washing supply device connector 54 by snapping the connector into the fitting 30.

Furthermore, the washing fluid supply device 28 can be any device structured and operable to retain a desired amount of washing fluid, e.g., any sterile cleaning solution such as a sterile saline solution, and controllably dispense the washing fluid into the washing fluid conduit 26, and hence, controllably dispense the washing fluid from the egress port 34 to wash and clean the objective lens 14 of the probe 18. For example, in various embodiments, as exemplary illustrated in FIG. 1, the washing fluid supply device 28 can be a syringe, e.g., 500 ml syringe, having a flexible tube attached to the nozzle of the syringe, whereby the distal end of the tube includes the connector 54 such that the tube is detachably connectable to the washing fluid supply fitting 30. In such embodiments, the syringe can be filled with the washing fluid, the flexible tube can be connected to the washing fluid conduit 26, via the connector 54 and fitting 30, and the washing fluid can be controllably dispensed from the egress port 34 by depressing the plunger of the syringe.

Alternatively, in various embodiments, as exemplary illustrated in FIG. 4, the washing fluid supply device 28 can comprise a flexible bulb having the connector 54 formed with or connected to a nozzle of the bulb such that the nozzle is detachably connectable to the washing fluid supply fitting 30. In such embodiments, the bulb can be filled with the washing fluid, the nozzle can be connected to the washing fluid conduit 26, via the connector 54 and fitting 30, and the washing fluid can be controllably dispensed from the egress port 34 by squeezing the bulb.

With further reference to FIGS. 1 and 4, in various embodiments, the lens washing system 10 can further include a handle 58 extending from a proximal end 22P of the sleeve 22. The handle 58 provides a means for the respective surgical telescopic instrument operator, e.g., the surgeon, to retain the sleeve 22 on the probe 18 in the embodiments wherein the inside diameter D, or dimensions, of the sleeve 22 is slightly larger than an outside diameter F, or dimensions, of the probe 18. Specifically, when the probe 18 is fully inserted into the sleeve 22, such that the portion of the distal end of the probe 18 including the objective lens extends slightly beyond, e.g., 1/16 inch to ½ inch, the sleeve distal end edge 46, the surgical telescopic instrument operator can hold the body of the surgical telescopic instrument (not shown) and place one or more fingers around the handle 58 to maintain proper placement and orientation of the sleeve 22 on the probe 18.

Referring now to FIGS. 1, 5A and 5B, although the distal end edge 46 of the sleeve 22 is illustrated in FIG. 1 as having a flat contour and being orthogonal to a longitudinal axis A of the sleeve 22, it is envisioned that the distal end edge can have any desired contour and any angular orientation with regard the axis A. For example, in various implementations, the distal end edge 46 of the sleeve 22 can have a curved contour and an angled orientation with regard to the longitudinal axis A, e.g., a 30° to 45° angled orientation, as exemplary illustrated in FIG. 5A. Or, in various other implementations, the distal end edge 46 of the sleeve 22 can have a flat contour and an angled orientation with regard to the longitudinal axis A, e.g., a 30° to 45° angled orientation, as exemplary illustrated in FIG. 5B.

Referring now to FIGS. 1, 2, 3, 4, 5A and 5B, in operation, prior to inserting the probe 18 of the respective surgical telescopic instrument into the body of a patient, the sleeve 22 is placed over the probe 18 such that the portion of the distal end of the probe 18 including the objective lens 14 extends slightly beyond, e.g., 1/16 inch to ½ inch, the sleeve distal end edge 46, as described above. The sleeve 22 is retained on the probe 18 either by the friction fit, the sock-like fit or the handle 58 as described above. After this, the probe and sleeve 18 and 22 can be introduced into a cavity within the patient's body to provide a means for the surgeon to see the internal target area. Subsequently, if the objective lens 14 becomes soiled with tissue particles, blood and/or other body fluids, obscuring what the surgeon can view through the respective surgical telescopic instrument, the surgical telescopic instrument operator can dispense a desired amount of washing fluid from the washing fluid supply device 28 into the internal lumen 38 of the washing fluid conduit 26.

As described above, the washing fluid is introduced into the conduit lumen 38 under pressure, e.g., 1 psi to 20 psi, whereby the washing fluid flows through the length of the lumen 38 as is dispensed from the washing fluid conduit 26 under pressure via the egress port 34. As also described above, the egress port 34 is formed within the conduit distal end 26D such that washing fluid dispensed from the egress port 34, is directed downward, and in various implementations, is angled toward the objective lens 14. Accordingly, the washing fluid is sprayed directly on and will contact the objective lens 14 with pressure or force, e.g. 1 psi to 20 psi, thereby removing any debris, fog, bodily fluids or other media obscuring the objective lens 14 from the objective lens 14 without removing the probe 18 from the patient's body. The debris, etc., and the washing fluid shed the lens 14 and fall into the body cavity, whereafter they will be disposed by the patients normal bodily functions. Moreover, the washing process, described herein, can be performed numerous times, as needed, without removing the probe 18 from the patient's body.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A lens washing system for cleaning the objective lens of a surgical telescopic instrument while the instrument is disposed within the body of a patient, said system comprising:
a hollow tubular sleeve structured and operable to be disposed over a probe of a surgical telescopic instrument such that a distal end of the probe including an objective lens of the surgical telescopic instrument extends past a distal end of the sleeve; and
a hollow tubular washing fluid conduit linearly and tangentially disposed along a longitudinal portion of an exterior surface of the sleeve such that a distal end of the conduit extends past the distal end and objective lens of the probe such that a washing fluid egress port formed in the distal end of the conduit is positioned even with or slightly past the distal end and objective lens of the probe such that washing fluid dispensed from the egress port is directed onto the objective lens to wash away any debris or media obscuring the objective lens.

2. The system of claim 1 further comprising a washing fluid supply device detachably connectable to the conduit, the washing fluid device structured and operable to controllably introduce washing fluid into an internal lumen of the conduit such that the washing fluid is dispensed from the egress port and directed onto the objective lens to wash away any debris or media obscuring the objective lens.

3. The system of claim 2, wherein the washing fluid supply device comprises a syringe.

4. The system of claim 2, wherein the washing fluid supply device comprises a flexible bulb.

5. The system of claim 2, wherein the washing fluid conduit comprises a washing fluid supply fitting structured and operable to detachably mate with a connector of the washing fluid supply device such that washing fluid dispensed from the washing fluid supply device will be introduced into the conduit internal lumen, flow through the internal lumen and be dispensed from the egress port onto the objective lens.

6. The system of claim 5, wherein the washing fluid supply fitting comprises a quick twist-connect fitting structured and operable to easily detachably connect with the washing supply device connector by inserting the connector into the fitting and slightly turning the connector.

7. The system of claim 1 further comprising a handle extending from a proximal end of the sleeve, the handle structured and operable to provide a means for retaining the sleeve on the probe.

8. A lens washing system for cleaning the objective lens of a surgical telescopic instrument while the instrument is disposed within the body of a patient, said system comprising:
a hollow tubular sleeve structured and operable to be disposed over a probe of a surgical telescopic instrument such that a distal end of the probe including an objective lens of the surgical telescopic instrument extends past a distal end of the sleeve; and
a hollow tubular washing fluid conduit linearly and tangentially disposed along a longitudinal portion of an exterior surface of the sleeve such that a distal end of the conduit extends past the distal end and objective lens of the probe such that a washing fluid egress port formed in the distal end of the conduit is positioned even with or slightly past the distal end and objective lens of the probe;
a washing fluid supply device that is detachably connectable to the conduit and is structures and operable to controllably introduce washing fluid into an internal lumen of the conduit such that the washing fluid is dispensed from the egress port and directed onto the objective lens to wash away any debris or media obscuring the objective lens.

9. The system of claim 8, wherein the washing fluid conduit comprises a washing fluid supply fitting structured and operable to detachably mate with a connector of the washing fluid supply device such that washing fluid dispensed from the washing fluid supply device will be introduced into the conduit internal lumen, flow through the internal lumen and be dispensed from the egress port onto the objective lens.

10. The system of claim 9, wherein the washing fluid supply fitting comprises a quick twist-connect fitting structured and operable to easily detachably connect with the washing supply device connector by inserting the connector into the fitting and slightly turning the connector.

11. The system of claim 8 further comprising a handle extending from a proximal end of the sleeve, the handle structured and operable to provide a means for retaining the sleeve on the probe.

12. The system of claim 8, wherein the washing fluid supply device comprises a syringe.

13. The system of claim 8, wherein the washing fluid supply device comprises a flexible bulb.

14. A method for cleaning the objective lens of a surgical telescopic instrument while the instrument is disposed within the body of a patient, said method comprising:
disposing a hollow tubular sleeve of a lens washing system over a probe of a surgical telescopic instrument, the sleeve having a length slightly shorter than the probe such that a distal end of the probe including an objective lens of the surgical telescopic instrument extends past a distal end of the sleeve;
connecting a washing fluid supply device to a washing fluid conduit of the lens washing system, the conduit being linearly and tangentially disposed along a longitudinal portion of an exterior surface of the sleeve such that a distal end of the conduit extends past the distal end and objective lens of the probe such that a washing fluid egress port formed in the distal end of the conduit is positioned even with or slightly past the distal end and objective lens of the probe; and
operating the fluid supply device to introduce washing fluid into an internal lumen of the conduit, whereby the washing fluid is dispensed from the egress port and directed onto the objective lens to wash away any debris or media obscuring the objective lens.

15. The method of claim 14, wherein connecting the washing fluid supply device to the washing fluid conduit comprises detachably connecting a connector of the washing fluid supply device to a washing fluid supply fitting disposed at a proximal end of the conduit, the supply fitting being fluidly connected to the egress port via the internal lumen of the conduit and comprising a quick twist-connect fitting structured and operable to easily detachably connect with the washing supply device connector by inserting the connector into the fitting and slightly turning the connector.

16. The method of claim 14, wherein disposing the hollow tubular sleeve of the lens washing system over the probe comprises retaining the sleeve on the probe utilizing a handle extending from a proximal end of the sleeve.

17. The method of claim 14, wherein the washing fluid supply device comprises a syringe, and wherein operating the fluid supply device to introduce washing fluid into an internal lumen comprises depressing a plunger of the syringe.

18. The method of claim 14, wherein the washing fluid supply device comprises a flexible bulb, and wherein operating the fluid supply device to introduce washing fluid into an internal lumen comprises squeezing the bulb.
